(19) United States
(12) Patent Application Publication
(10) Pub. No.: US 2015/0221239 A1
(43) Pub. Date: Aug. 6, 2015

(54) DETACHABLE LABEL PORTION AND METHOD FOR PRODUCING THE SAME

(71) Applicant: Marie Couture, Quebec City (CA)

(72) Inventor: Marie Couture, Quebec City (CA)

(21) Appl. No.: 14/169,982

(22) Filed: Jan. 31, 2014

(51) Int. Cl. G09F 3/02; G09F 3/00; G09F 3/10

(52) U.S. Cl. CPC G09F 3/02; G09F 3/10; G09F 3/0288; G09F 2003/0222; G09F 2003/0245; G09F 2003/0272

(57) ABSTRACT

The present document describes a label for detachment from a container. The label comprises a front side free of adhesive and a back side which is for extending over the container surface. The label comprises: a fixed label portion for adhesively fixing on the container surface; a detachable label portion for non-adhesively and detachably affixing on the container surface and comprising a detachable border connected to the fixed label portion and an inner side which is a part of the back side of the label; an adhesive applied to the back side of the label; an adhesive disabler, applied to the adhesive, at least on the detachable label portion; and a weakness line provided at the detachable border for facilitating a detachment of the detachable label portion from the fixed label portion. The adhesive disabler is for eliminating adhesiveness of the inner side of the detachable label portion.

### BACKGROUND

(a) Field

The subject matter disclosed generally relates to labels for containers. More specifically, the subject matter relates to labels having a detachable portion.

(b) Related Prior Art

Sometimes, a customer eating in a restaurant orders wine and drinks it, but afterwards forgets the name of the product when trying to buy it in a store. Similar situations may exist if someone drinks the wine when dining at a friend's house, or when tasting it at a fair. Of course, this inconvenience may rise with various types of products, not only wine.

A solution to this problem may be provided by allowing the customer to leave the place with a convenient “souvenir” from the product, such as a piece of paper, which can easily be kept for future reference. Since bottles and other types of containers are often labeled, having a detachable label portion may be practical.

However, prior art detachable label portions have many drawbacks which cause them to be inconvenient in various situations. For example, some prior art detachable labels are glued to the container using weak glue, described for example in US20040007557A1, in WO03054837A1 or in WO03001485A1. In all cases, either the container or the label portion will become sticky and unpleasant to manipulate after the detachment, which is not suitable for luxury products. Furthermore, the glue behind the label portion may render the detachment harder to perform.

Other techniques for producing a detachable label include providing a detachable label portion which is put in place on an underlying label fixed to the container, such as what is described in EP1430461B1. The presence of glue causes the same issues as mentioned above. Furthermore, the uncovered underlying label may also be unaesthetic.

These drawbacks can be in contradiction with a marketing strategy. For example, if the container is transparent and if the content is aesthetic (for example a fine cider or a rosé wine), it may be a part of the marketing strategy to unveil the color of the product in the container when the detachable label portion is detached. This marketing requirement cannot be met with existing methods, because the underlying layer of label or the glue residue obstruct the view of the product in the container.

Since a detachable label is especially appropriate for luxury products such as wine, ciders and other fine beverages, the stickiness of the bottle after a detachment of the label and the difficulty of detachment when glue is used are even more relevant issues.

There is therefore a need for detachable labels for containers (e.g. bottles of fine beverages) which do not leave any glue residue either on the detached label or on the uncovered container.

### SUMMARY

According to an embodiment, there is provided a label for detachment from a container having a container surface, the label comprising a front side and a back side which is for extending over the container surface, the front side of the label being free of adhesive, the label comprising: a first fixed label portion for adhesively fixing on the container surface; a detachable label portion for non-adhesively and detachably affixing on the container surface, the detachable label portion comprising a first detachable border connected to the first fixed label portion, the detachable label portion comprising an inner side which is a part of the back side of the label; an adhesive applied to the back side of the label; an adhesive disabler, applied to the adhesive, at least on the detachable label portion, the adhesive disabler for eliminating adhesiveness of the inner side of the detachable label portion; and a first weakness line provided at the first detachable border for facilitating a detachment of the detachable label portion from the first fixed label portion.

According to another embodiment, the detachable label portion further comprises a second detachable border, the label further comprising: a second fixed label portion, connected to the second detachable border of the detachable label portion, for adhesively fixing on the container surface; and a second weakness line provided at the second detachable border for facilitating a detachment of the detachable label portion from the second fixed label portion.

According to another embodiment, the first fixed label portion and the second fixed label portion are adhesively fixed on the container surface, wherein the detachable label portion is detachably mounted on the container surface.

According to another embodiment, the detachable label portion further comprises an outer side, at least one of the outer side and the inner side displaying at least one of textual data and graphical data.

According to another embodiment, the detachable label portion further comprises a tab mounted thereon for facilitating the detachment.

According to another embodiment, the first fixed label portion is adhesively fixed on the container surface and wherein the detachable label portion is non-adhesively and detachably affixed on the container surface.

According to another embodiment, the first weakness line is a series of perforations.

According to another embodiment, the adhesive disabler comprises at least one of an adhesive remover, an adhesive masker and an adhesive blocker.

In another aspect of the invention, there is provided a manufacturing method for producing a label comprising a first fixed label portion and a detachable label portion for detachment from a container, the label comprising a back side, the detachable label portion comprising an inner side which is a part of the back side of the label, the method comprising: providing the label which comprises an adhesive on the back side thereof; applying an adhesive disabler on the inner side of the detachable label portion for substantially eliminating adhesiveness of the inner side of the detachable label portion; and introducing a weakness line on the label which defines a first detachable border between the detachable label portion and the first fixed label portion.

According to another embodiment, providing the label to a printing device comprises providing a label which further comprises a second fixed label portion, the manufacturing method further comprising introducing on the label a second weakness line which define a second detachable border between the detachable label portion and the second fixed label portion.

According to another embodiment, there is further provided securing a tab on the detachable label portion for facilitating the detachment thereof.

According to another embodiment, there is further provided securing the back side of the label on a surface of the container.

According to another embodiment, there is further provided, prior to applying the adhesive disabler, printing on the inner side of the detachable label portion.

According to another embodiment, the detachable label portion further comprises an outer side which is a part of the front side of the label, the manufacturing method further comprising, prior to printing on the inner side of the detachable label portion, printing on the outer side of the detachable label portion.

According to another embodiment, printing on the inner side and on the outer side of the detachable label portion comprises printing at least one of textual data and graphical data.

According to another embodiment, introducing a weakness line comprises piercing through the label a series of perforations using a piercing die.

As will be realized, the subject matter disclosed and claimed is capable of modifications in various respects, all without departing from the scope of the claims. Accordingly, the drawings and the description are to be regarded as illustrative in nature, and not as restrictive and the full scope of the subject matter is set forth in the claims.

### BRIEF DESCRIPTION OF THE DRAWINGS

Further features and advantages of the present disclosure will become apparent from the following detailed description, taken in combination with the appended drawings, in which:

FIG. 1 is a front view illustrating an embodiment of a container having an intact label thereon;

FIG. 2 is a front view illustrating an embodiment of a container having a label portion being detached therefrom;

FIG. 3 is a front view illustrating an embodiment of a container with a label portion detached therefrom;

FIG. 4 is a front view illustrating an embodiment of a container having a label portion being detached from a lower fixed label portion;

FIG. 5 is a front view illustrating an embodiment of a container having a label portion being detached from an upper fixed label portion;

FIG. 6 is a front view illustrating an embodiment of a container having a vertical label portion being detached therefrom;

FIG. 7 is a flowchart illustrating the method for producing a label comprising a detachable label portion.

It will be noted that throughout the appended drawings, like features are identified by like reference numerals.

### DETAILED DESCRIPTION

In embodiments there are disclosed a detachable label portion for a container and a method for producing the same, wherein the detachable label portion does not substantially leaves a glue residue when it is detached.

### Detachable Label Portion

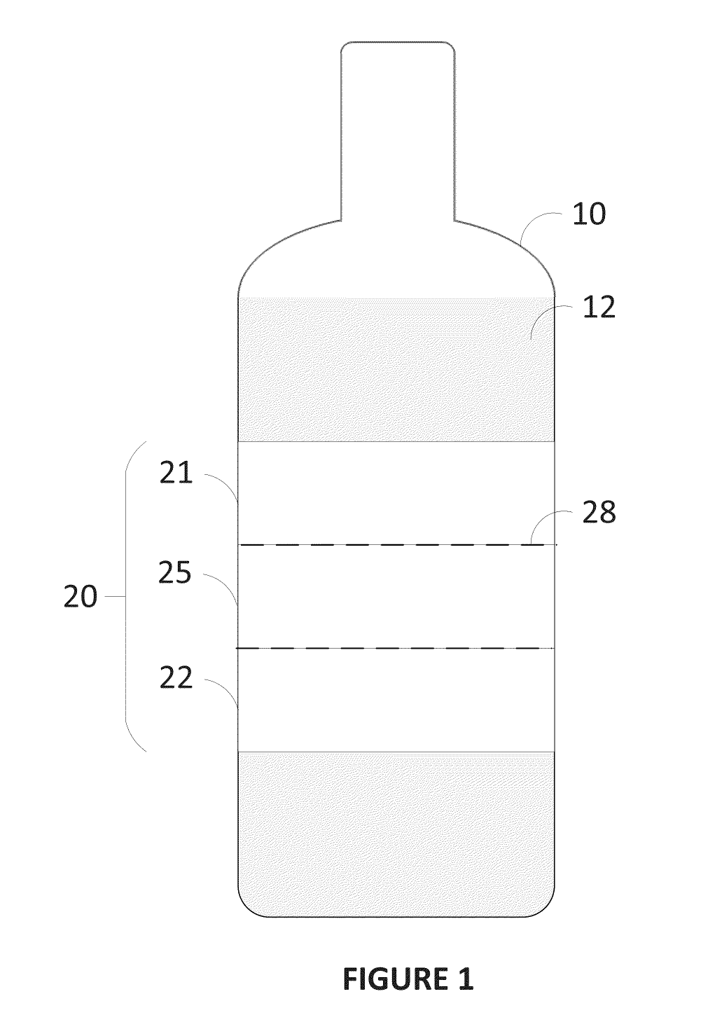

Referring now to the drawings, and more particularly to FIG. 1, a front view illustrates a container 10 having a label 20 installed thereon. The container 10 is illustrated as a bottle, but may be any type of container: bottle, box, jar, bucket, can, Mason jar, etc. Typically, but not necessarily, the container 10 contains a product 12. The product may be any type of liquid, gaseous or solid product. A detachable label portion is well adapted for products that consumers want to remember, for example fine beverages: wine, cider, spirit, fine beer, etc., although any other type of product 12 may be found in the container 10.

The container has a surface with a circumference or perimeter. The label 20 may surround the whole circumference or perimeter, thereby defining a ribbon all around the container. It may also cover only partially the circumference or perimeter of the surface of the container 10.

In all embodiments, the label 20 comprises a fixed label portion 21. The fixed label portion 21 is said to be fixed because it is not made for an easy detachment by a consumer. It is fixed on the container 10 using glue. Even though the fixed label portion 21 is said to be fixed, it should be understood that by using, for example, scraping means or industrial processes in the recycling industry, the fixed label portion 21 could be removed. The fixed label portion 21 should however be considered as fixed in a normal context of use.

According to an embodiment, as in FIG. 1, a second fixed label portion 22 may be provided. More generally, a plurality of fixed label portions may be provided if this useful in a given context.

The label 20 comprises not only one or more fixed label portions, but also a detachable label portion 25. The detachable label portion 25 is characterized in that it may be easily detached by a consumer. The detachable label portion 25 is adjacent to at least the first fixed label portion 21. If there is provided a second fixed label portion 22, the detachable label portion 25 is adjacent to both the first fixed label portion 21 and the second fixed label portion 22.

In order to provide easy detachment from the container 10 and the fixed label portion(s), a weakness line 28 is made at the side which is common to the detachable label portion 25 and the fixed label portion(s) (21, 22). The weakness line 28 usually consists of a series of perforations, which is a plurality of separate holes or slits which are substantially placed along a line. In some cases, the weakness line 28 is a simple perforation having a linear shape, or a weak bond (e.g. thinner paper or a series of hollows), or any other feature that ease the operation of tearing the junction between the detachable label portion 25 and the fixed label portion(s).

The width and length of the separations 28 and the distance between each one of them has to be chosen to offer a detachment possibility to a user which is easy to perform, without having a detachable label portion 25 that is too fragile.

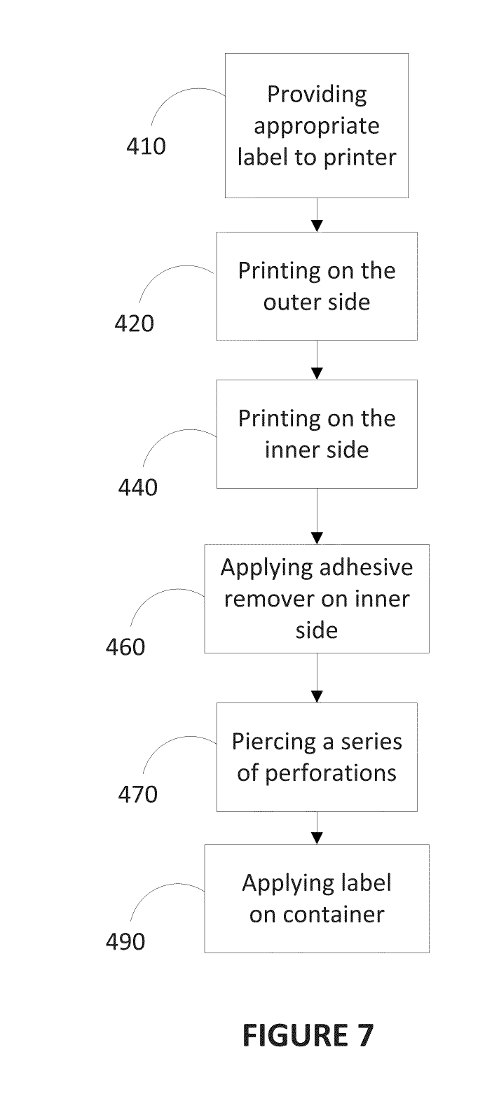

All label portions may be made of paper, plastic, or plasticized paper, or any other material known in the art of labeling to be proper for such a use. According to an embodiment, the whole label 20 is made of 3-mil matte white synthetic paper, which is moisture-resistant. Such a material is provided with adhesive on one side. Resistance to moisture has to apply to both the material and the adhesive in order to be effective. Resistance to moisture is a useful feature if the label is to be plunged in water or ice (a common situation for wine bottles). The steps required to remove adhesiveness of the detachable label portion 25 and to add the weakness line holes 28, are described hereinbelow with reference to FIG. 7.

According to an embodiment, as shown in FIG. 1, the first fixed label portion 21 and the second fixed label portion 22 are placed as an upper fixed label portion and a lower fixed label portion. It allows the detachable label portion 25 to be placed between both fixed label portions. Therefore, both the upper and the lower sides of the detachable label portion 25 are secured while the detachable label portion 25 is on the container 10. If one of the fixed label portions is missing (which is possible), one of the upper and the lower sides of the detachable label portion 25 could hang freely, a situation which may be undesirable in some cases. Having two fixed label portions thus provides a better solidity to the detachable label portion 25 before it is detached.

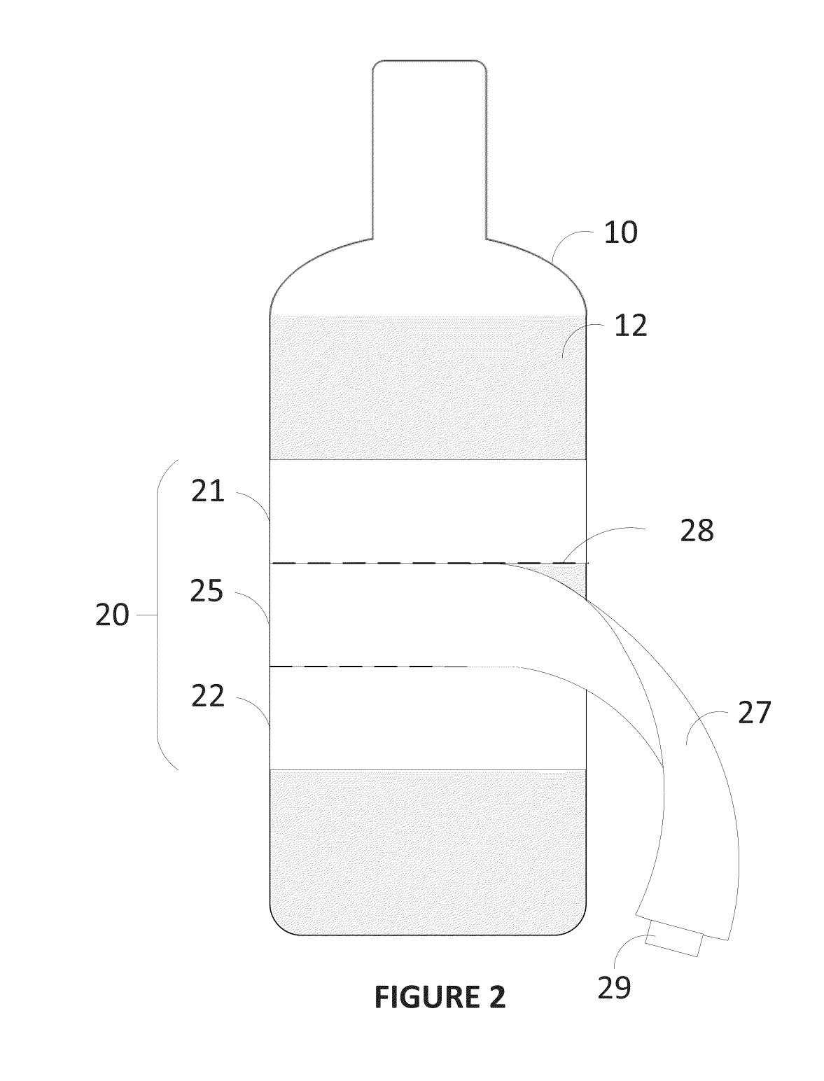

Now referring to FIG. 2, there is shown an embodiment of a container 10 having a detachable label portion 25 being detached therefrom. For an easy detachment, a tab 29 may be installed on the detachable label portion 25, providing a pulling capacity of the detachable label portion 25 by a user. This tab 29 can ease the initiation of the detachment.

During the process of detachment, the detachable label portion 25 is separated from the container 10 and from the fixed label portion(s), by a tearing of the side(s) joining the detachable label portion 25 and the fixed label portion(s) along the weakness line 28.

Before detachment, only the detachable label portion outer side 26 is visible, but during the detachment, the detachable label portion inner side 27 becomes visible too.

The label 20 is therefore made of a plurality of parts: at least a fixed label portion (21, 22) and a detachable label portion 25. The label 20 has a front side, which is visible, and on which there is no adhesive, unless a specific reason requires that some adhesive be applied thereon. The detachable label portion outer side 26 is a part of this front side of the label. The label 20 also has a back side on which adhesive is already applied. The detachable label portion outer side 26 is a part of the back side of the label 20. It means that the detachable label portion outer side 26 initially has glue thereon, as for the fixed label portions (21, 22). Whereas the fixed label portions (21, 22) keep their adhesive, which serves as a fixing means on the container 10, the detachable label portion outer side 26 has its adhesiveness eliminated by the use of an adhesive disabler, as described with reference to FIG. 7. The detachable label portion 25 is defined as the portion enclosed within the detachable borders, i.e. the weakness line 28, or also by the border of the label 20 itself. The back side of the area enclosed within these borders is the detachable label portion inner side 27 and it is on this whole area that the adhesiveness should be substantially eliminated with an adhesive disabler in order to allow the detachment of the detachable label portion 25. According to another embodiment, the adhesive disabler may comprise an adhesive remover, an adhesive masker or an adhesive blocker. The adhesive disabler can create the desired effect by chemical reaction or by providing an additional coating of material (e.g., a varnish).

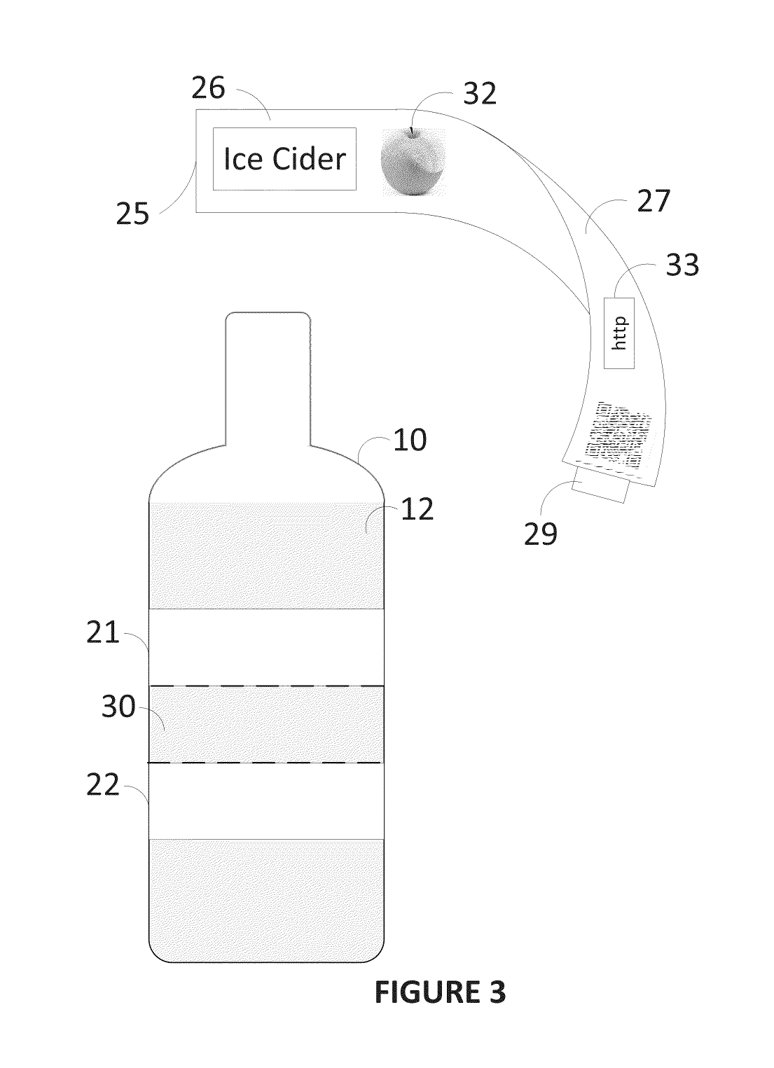

Now referring to FIG. 3, there is shown an embodiment of a container 10 having a detachable label portion 25 detached therefrom. The place left vacant by the detached detachable label portion 25 is the uncovered container surface 30. Since the detachable label portion 25 is not adhesive when it is installed on the container 10, it means that there is no sticky residue on the uncovered container surface 30, nor is there on the detachable label portion inner side 27.

If the container 10 is transparent or translucent, uncovering the uncovered container surface 30 allows seeing the product 12 therethrough.

The detachable label portion 25, on its outer side 26, may display front information 32, and on its inner side 27, back information 33. The front information 32 may comprise, for example, a name of the product 12, a name of a producer, a logo, basic information on the product (e.g. vine variety and producer country) or any other textual or graphical information. The back information 33 may comprise a QR code, a website, information about the product 12 or its producer, or any other textual and graphical information. Fragrance or textural information can also be thought of, but adding them requires further challenges.

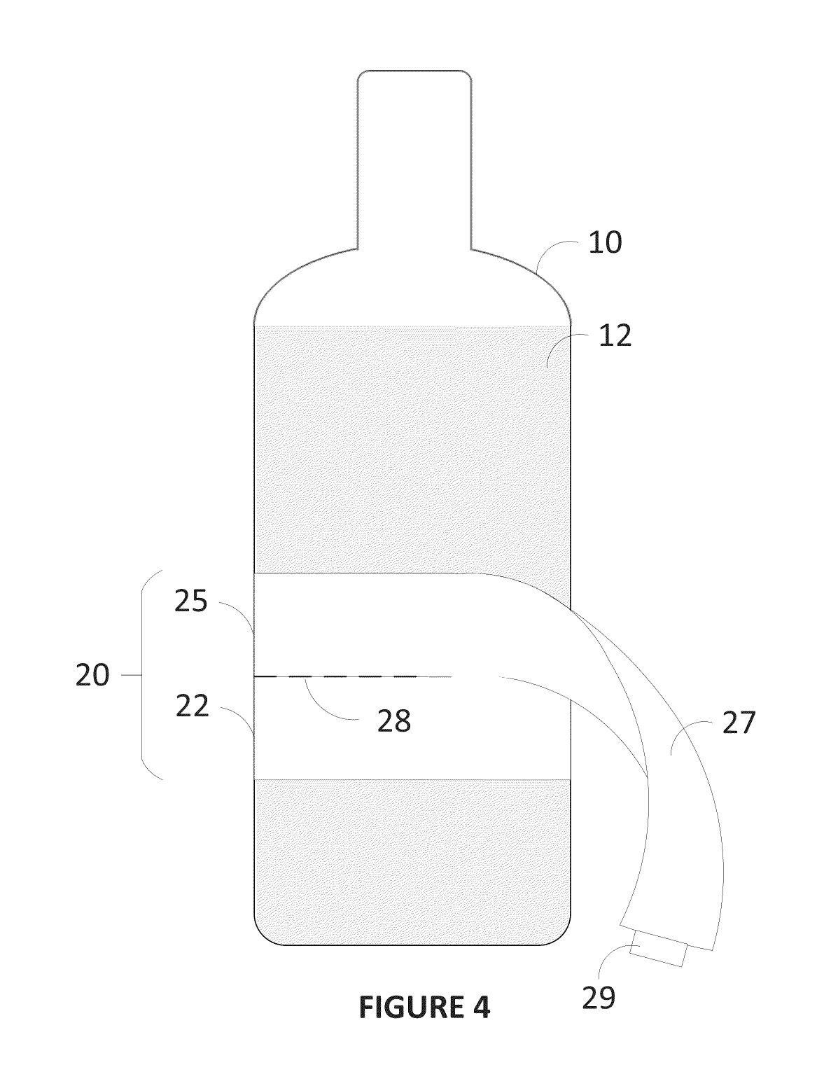

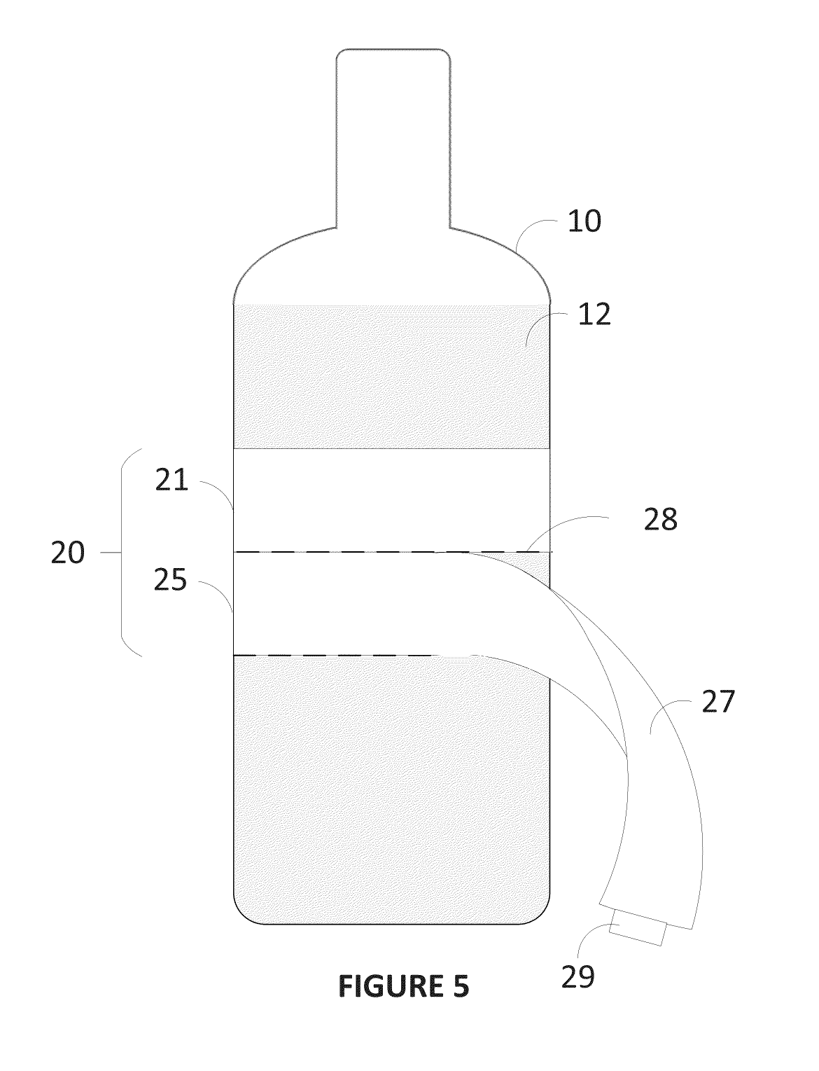

Now referring to FIGS. 4 and 5, there are shown illustrations of embodiments in which there is only one fixed label portion. In FIG. 4, the detachable label portion 25 is being detached from a lower fixed label portion 22. In FIG. 5, the detachable label portion 25 is being detached from an upper fixed label portion 21.

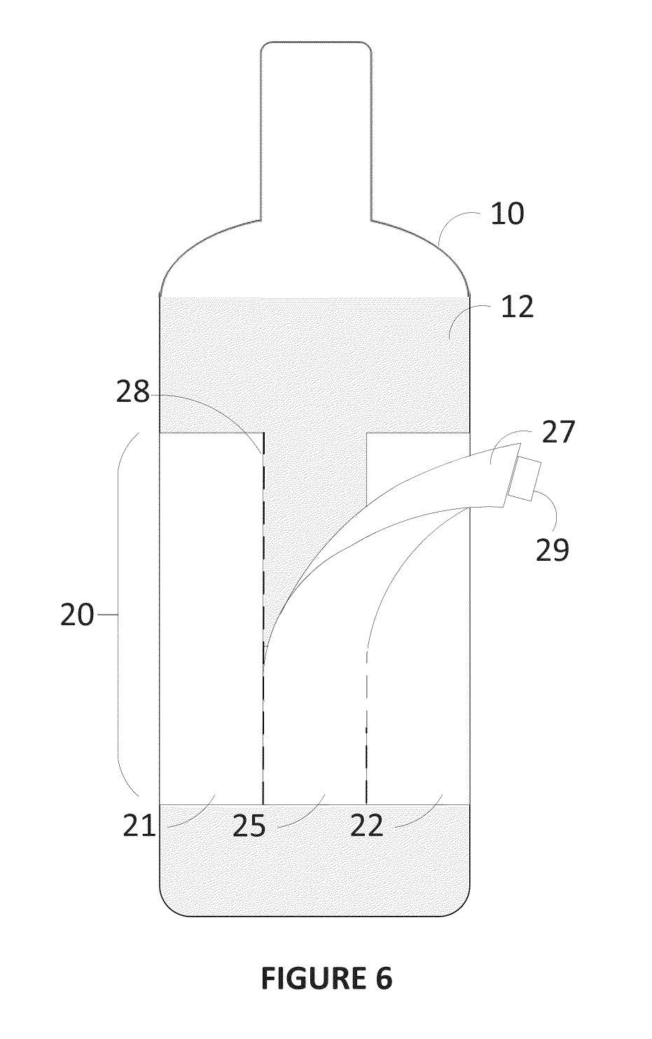

The orientation of the label 20 can be different, such as in FIG. 6, in which the detachable label portion 25 is vertical (i.e., parallel to the longitudinal axis of the illustrated bottle 10). In this case, the first and the second fixed label portions (21, 22) can be the same label portion surrounding the container 10, or they can be two separate label portions, in which case they do not surround the container 10. One of these label portions may be absent, as shown in FIGS. 4 and 5.

### Method for Producing a Detachable Label Portion

Now referring to FIG. 7, there is shown a method for producing a label having a detachable label portion as described above.

A label (such as a 3-mil matte synthetic paper label) with adhesive on one side should initially be provided. The label may be part of a roll comprising a plurality of adjacent labels. The label has to undergo a series of steps that removes the adhesive on a part of the label (more precisely, on the detachable label portion inner side 27) to create a non-adhesive portion. A series of perforation holes 28 are then provided so that the non-adhesive portion becomes detachable.

Such steps may be described as follows, in reference with FIG. 7:

Step 410: Providing a label having adhesive on a back side. The label should be of the types described above. A 3-mil matte synthetic paper is an example of a moisture-resistant label. The label that is provided can be a part of a roll comprising a plurality of labels, or it can be a standalone label.

Step 420: Printing on the detachable label portion outer side 26, if front information 32 (graphical or textual information) is wanted on this side.

Step 440: Printing back information 33 on the detachable label portion inner side 27.

Step 460: Applying an adhesive disabler on the detachable label portion inner side 27 for substantially eliminating its adhesiveness. Various types of adhesives and of adhesive disablers exist, so the combination must be chosen so that the adhesive disabler works with the adhesive.

Step 470: Piercing through the label 20 a weakness line 28 which define a first detachable border between the detachable label portion 25 and the first fixed label portion 21. If there is a second fixed label portion 22, a second weakness line 28 is also pierced.

Eventually, the label 20 is applied to a container 10 (step 490), although this may occur later, in another location. It is to be understood that applying the label 20 comprises adhesively fixing the fixed label portion(s) (21, 22), which have adhesive on their back side, whereas the detachable label portion 25 is non-adhesively and detachably affixed on the surface of the container.

Some more steps can be required depending on the specific conditions in which the method is conducted. For example, if the label 20 is part of a roll in which a plurality of labels are found, the back side, on which there is adhesive, can be covered with a sheet that protects the adhesive from the environment and from the rest of the roll. Before printing on the inner side 27 (step 440), this protection sheet needs to be removed. Sometimes, the protection sheet can even be put back, for example if the printed label has to be rolled again to be shipped in another location in which the labels will be applied to a container.

Other additions may be provided. For example, a tab 29 can be secured on the detachable label portion 25 to ease its detachment.

While preferred embodiments have been described above and illustrated in the accompanying drawings, it will be evident to those skilled in the art that modifications may be made without departing from this disclosure. Such modifications are considered as possible variants comprised in the scope of the disclosure.

1. A label for detachment from a container having a container surface, the label comprising a front side and a back side which is for extending over the container surface, the front side of the label being free of adhesive, the label comprising:
a first fixed label portion for adhesively fixing on the container surface;
a detachable label portion for non-adhesively and detachably affixing on the container surface, the detachable label portion comprising a first detachable border connected to the first fixed label portion, the detachable label portion comprising an inner side which is a part of the back side of the label;
an adhesive applied to the back side of the label;
an adhesive disabler, applied to the adhesive, at least on the detachable label portion, the adhesive disabler for eliminating adhesiveness of the inner side of the detachable label portion; and
a first weakness line provided at the first detachable border for facilitating a detachment of the detachable label portion from the first fixed label portion.

2. The label of claim 1, wherein the detachable label portion further comprises a second detachable border, the label further comprising:
a second fixed label portion, connected to the second detachable border of the detachable label portion, for adhesively fixing on the container surface; and
a second weakness line provided at the second detachable border for facilitating a detachment of the detachable label portion from the second fixed label portion.

3. The label of claim 2, wherein the first fixed label portion and the second fixed label portion are adhesively fixed on the container surface, wherein the detachable label portion is detachably mounted on the container surface.

4. The label of claim 1, wherein the detachable label portion further comprises an outer side, at least one of the outer side and the inner side displaying at least one of textual data and graphical data.

5. The label of claim 1, wherein the detachable label portion further comprises a tab mounted thereon for facilitating the detachment.

6. The label of claim 1, wherein the first fixed label portion is adhesively fixed on the container surface and wherein the detachable label portion is non-adhesively and detachably affixed on the container surface.

7. The label of claim 1, wherein the first weakness line is a series of perforations.

8. The label of claim 1, wherein the adhesive disabler comprises at least one of an adhesive remover, an adhesive masker and an adhesive blocker.

9. A manufacturing method for producing a label comprising a first fixed label portion and a detachable label portion for detachment from a container, the label comprising a back side, the detachable label portion comprising an inner side which is a part of the back side of the label, the method comprising:
providing the label which comprises an adhesive on the back side thereof;
applying an adhesive disabler on the inner side of the detachable label portion for substantially eliminating adhesiveness of the inner side of the detachable label portion; and
introducing a weakness line on the label which defines a first detachable border between the detachable label portion and the first fixed label portion.

10. The manufacturing method of claim 9, wherein providing the label to a printing device comprises providing a label which further comprises a second fixed label portion, the manufacturing method further comprising introducing on the label a second weakness line which define a second detachable border between the detachable label portion and the second fixed label portion.

11. The manufacturing method of claim 9, further comprising securing a tab on the detachable label portion for facilitating the detachment thereof.

12. The manufacturing method of claim 9, further comprising securing the back side of the label on a surface of the container.

13. The manufacturing method of claim 9, further comprising, prior to applying the adhesive disabler, printing on the inner side of the detachable label portion.

14. The manufacturing method of claim 13, wherein the detachable label portion further comprises an outer side which is a part of the front side of the label, the manufacturing method further comprising, prior to printing on the inner side of the detachable label portion, printing on the outer side of the detachable label portion.

15. The manufacturing method of claim 14, wherein printing on the inner side and on the outer side of the detachable label portion comprises printing at least one of textual data and graphical data.

16. The manufacturing method of claim 9, wherein introducing a weakness line comprises piercing through the label a series of perforations using a piercing die.
